(19) United States
(12) Patent Application Publication
(10) Pub. No.: US 2003/0173311 A1
(43) Pub. Date: Sep. 18, 2003

(54) Servo sandwich filter assembly

(76) Inventors: Bob Younger, Downers Grove, IL (US); Terrence Lee Loomis, Westville, IN (US)

Correspondence Address: BARNES & THORNBURG, P.O. BOX 2786, CHICAGO, IL, 60690-2786, US

(21) Appl. No.: 10/349,711

(22) Filed: Jan. 23, 2003

Related U.S. Application Data
(60) Provisional application No. 60/351,260, filed on Jan. 23, 2002.

(51) Int. Cl. B01D 35/30

(52) U.S. Cl. 210/791; 210/232

(57) ABSTRACT

A filter assembly for filtering hydraulic fluid flow from a hydraulic fluid source such as a manifold to a hydraulic fluid receiving component, such as a servo valve, associated with the manifold. The filter assembly includes a housing which defines a cavity for receiving a filter. Passages are provided in the housing for passing hydraulic fluid from a hydraulic fluid source to a hydraulic fluid receiving component. At least one of the passages communicates with the cavity for delivering hydraulic fluid for filtering by the filter retained in the cavity. First and second adapter plates are provided and positioned between the housing and the manifold and servo valve, respectively. The first adapter plate includes passages which extend therethrough for matching ports on a hydraulic fluid source and the housing. The second adapter plate includes passages extending therethrough for matching ports on the housing and a hydraulic fluid receiving component such as a servo valve. Also disclosed is a method for filtering hydraulic fluid using the filter assembly as disclosed and a method for containing a filter assembly using the disclosed filter assembly.

### CROSS-REFERENCE TO RELATED APPLICATIONS

This application claims the benefit of U.S. Provisional Application No. 60/351,260 filed Jan. 23, 2002.

### BACKGROUND

The present disclosure relates to an improved sandwich filter assembly and system for filtering hydraulic fluid used in a hydraulic operating system.

By way of review, there are many hydraulically operated systems or hydraulic systems used in manufacturing to hydraulically control the operation of machines, such as injection molding devices, material stamping presses, etc. Hydraulic systems, while being replaced by electronic systems in some areas, are still preferred because they are highly efficient and provide desired power to weight ratios. These hydraulic systems include one or several control valves or servo valves. The servo valve is an important component in the hydraulic system which must be maintained in order to operate properly. Downtime to replace a servo valve can be expensive, because it will cease operation of the process associated with the hydraulic system and result in potential loss of production time and profit. Such hydraulic systems also include a filtering system or filter system to filter out material which might otherwise interfere with the smooth operation of the servo valves of the hydraulic system. Such filter systems are attached at an appropriate location in the hydraulic system.

Prior art filter systems typically extend outwardly from the side of a manifold of the hydraulic system. Generally, such prior art filter systems are often large metallic canisters. Such prior art filter systems extend from the side of a servo valve attached to the manifold. These canisters can be quite heavy, complex and expensive to manufacturer, and use a pleated, generally cylindrical filter cartridge.

One of the problems with the prior art filter system is that it tends to cantilever outwardly from the manifold potentially causing seal problems. Because of a vertically oriented canister shape, such prior art typically cannot be drained of the hydraulic fluid when changing the filter cartridge. As a result of being unable to drain the hydraulic fluid, some material, which might normally be filtered or drained out of the hydraulic system, remains in the hydraulic system.

Additionally, by extending outwardly from the side of the manifold, such prior art filter systems are subject to damage or destruction as a result of impact by other equipment or workers. These prior art filter systems are very expensive to manufacture and often are difficult to obtain replacements. As a result, users of such prior art filter systems must maintain an inventory to accommodate sudden damage or loss of filter systems. Moreover, the complex and expensive manufacturing of these filter systems make them difficult to service and maintain. Periodic filter changing is necessary but difficult and expensive. The cost and availability of these filter systems make them difficult to maintain in inventory but, such filter systems are necessary in many hydraulic systems.

The present disclosure is a sandwich filter assembly which solves many of the problems of the prior art systems. In a hydraulic operating system, valves and other devices may be sandwiched against each other at a manifold in order to achieve various functionality. However, the disclosed sandwich filter assembly is contained within the sandwich of devices and is positioned in a space above the manifold. Having the filter system contained in a sandwich of devices helps to improve the ease and efficiency of manufacture as well as service and maintenance of the sandwich filter assembly. The sandwich filter assembly is positioned above or at least in line with the manifold so as to protect it from accidental and unintended impact. Further, by positioning the sandwich filter assembly of the present invention in a generally horizontal alignment, hydraulic oil and contamination collected by the sandwich filter assembly will be easily drained and removed during maintenance.

The disclosed sandwich filter assembly may embody a sandwich filter housing or body which is attached by use of an upper valve adapter plate and a lower valve adapter plate to the servo valve of a hydraulic operating system. The sandwich filter housing defines a generally axially elongated cavity.

A filter cap is attached to the sandwich filter housing and has a generally axially elongated, hollow filter element support, such as a mandrel, extending from and attached thereto. A filter element in the form of a pleated, generally cylindrical cartridge-type filter, is positioned over the filter element support and in the cavity of the sandwich filter housing. Hydraulic fluid flows into the cavity of the housing passes through the filter element, whereby contaminants and particulate matter are stripped from the fluid flow. Hydraulic fluid passing through the filter element flows into a passage defined by the hollow filter element support.

When replacing the filter element, the filter cap is removed from the sandwich filter housing and the hollow filter element support and filter element are extracted. The oil remaining in the cavity of the sandwich filter housing drains therefrom so as to assure that the maximum amount of particulate matter and contamination will be removed from the hydraulic system. A clean filter element is placed on the hollow filter element support and inserted into the cavity or the housing.

The sandwich filter assembly is adaptable to fit on any number of servo valve assemblies and manifolds. A variety of standard adapter plates can be provided for use with the sandwich filter housing to adapt a standard, generally generic sandwich filter housing to a variety of configurations. Seals are used to prevent leakage of hydraulic fluid from the sandwich filter housing. The seals are o-rings countersunk within the sandwich filter housing and retained between the housing and corresponding adapter plate. The assembly is generally vertically aligned causing improved sealing between the seals and components. In contrast, the prior art filter systems cantilevered or “hang-off” the side of the valves causing separation between the seals and components.

The disclosed sandwich filter assembly improves the life of the servo valves by improving the filtering and sealing characteristics of the assembly. By increasing contamination removal there will be a substantial increase in the period of use of the servo valve. The increase in the period of use results from the removal of contamination which might otherwise interfere or damage the operation of the servo valve.

The disclosed sandwich filter assembly is uncomplicated, simplified and has a reduced number of components. This improvement helps to increase the reliability of the sandwich filter assembly and increase the ease of maintenance. The ease of maintenance helps to improve the reliability of the sandwich filter assembly because the regular program maintenance will typically be accomplished with a high degree of success. In contrast, the prior art filter systems are rather complex, thereby discouraging maintenance and reducing the chance of successful maintenance. features of the sandwich filter assembly will become apparent to those skilled in the art upon consideration of the following detailed description of drawings.

### BRIEF DESCRIPTION OF THE DRAWINGS

The detailed description particularly refers to the accompanying figures in which:

FIG. 1 is an exploded diagrammatic illustration of a sandwich filter assembly positioned proximate to a process manifold;

FIG. 2 is a cross-sectional view of a sandwich filter housing of the sandwich filter assembly;

FIG. 3 is a side elevational view of a filter cap and an axially extending hollow filter element support of the sandwich filter assembly;

FIG. 4 is an end view of the hollow filter element support taken along line 4-4 in FIG. 3;

FIG. 5 is a side elevational view of a cartridge-type filter element as used in the sandwich filter assembly;

FIG. 6 is a top plan view of the filter housing of the sandwich filter assembly;

FIG. 7 is a top plan view of a range of standard port patterns for a first adapter plate and a second adapter plate;

FIG. 8 is a top plan view of the first adapter plate;

FIG. 9 is a cross-sectional view of the first adapter plate taken along line 9-9 in FIG. 8;

FIG. 10 is a side elevational view of the first adapter plate of FIG. 8 taken along line 10-10 in FIG. 8;

FIG. 11 is a top plan view of the second adapter plate;

FIG. 12 is a cross-sectional view of the second adapter plate taken along line 12-12 in FIG. 11;

FIG. 13 is a side elevational view of the second adapter plate of FIG. 11 taken along line 13-13 in FIG. 11; and

FIG. 14 is a partial cross-sectional side elevational view of an assembled sandwich filter assembly.

### DETAILED DESCRIPTION OF THE DRAWINGS

While the present disclosure may be susceptible to embodiment in different forms, there is shown in the drawings, and herein will be described in detail, an embodiment with the understanding that the present description is to be considered an exemplification of the principles of the disclosure and is not intended to limit the invention to that as illustrated and described herein. It is to be understood that the invention is not limited in its application to the details of construction and the arrangement of components set forth in the following description or illustrated in the drawings.

With reference to the figures, FIG. 1 generally shows a sandwich filter assembly 2 including from bottom to top, a first adapter plate 3, which can be attached to a hydraulic fluid source, for example, a process manifold 4; a sandwich filter housing 6, to which the first adapter plate 3 is attached; and a second adapter plate 8, which can be attached to both the sandwich filter housing 6 and hydraulic fluid receiving component, for example a servo valve 10. It is anticipated that while the aforementioned “sandwich” configuration may be desired, the positioning of additional elements could be placed between the couplings of the first adapter plate 3, process manifold 4, and sandwich filter housing 6; and the second adapter plate 8, sandwich filter housing 6, and servo valve 10, respectively. The hydraulic fluid receiving component 10 may be in the form of a different component such as a proportional valve or other device.

The sandwich filter assembly 2 includes a sandwich filter housing 6, first adapter plate 3 and second adapter plate 8. The sandwich filter assembly 2 is positioned between and attaches to the process manifold 4 and the servo valve 10. The first adapter plate 3 includes a first surface 5 which includes ports and passages to communicate with ports provided on a corresponding surface 4a of the process manifold 4. A second surface 7 of the first adapter plate 3 abuts a corresponding surface 6a of the sandwich filter housing 6 and includes a port configuration for communicating with ports provided on the sandwich filter housing 6. The second adapter plate 8 includes a first surface 9 which abuts a corresponding surface 6b of the sandwich filter housing 6 and includes ports for communicating with the sandwich filter housing 6. A second surface 11 of the second adapter plate 8 abuts a corresponding surface 10a of the servo valve 10 and includes a port and passage configuration for communicating with the servo valve 10.

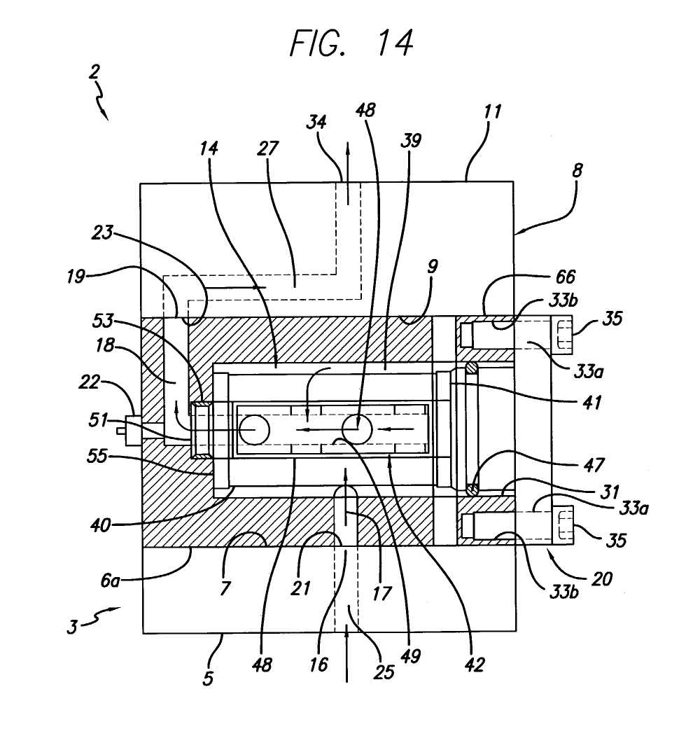

The sandwich filter assembly 2 allows a single sandwich filter housing to be used with a variety of servo valve and process manifold 4 combinations by use of first and second adapter plates 3, 8 which can be provided with a range of port configurations. The range of port configurations provided by way of the first adapter plate 3 and the second adapter plate 8 allow the sandwich filter housing 6 to communicate with the variety of combinations of process manifold 4 and servo valve 10 port arrangements. The assembly 2 is attached to the manifold 4 and valve 10 using techniques known to those of skill in the art. For example, as shown in FIGS. 6, 8, 10, 11 and 13 fastener passages 15 are provided to receive fasteners such as bolts to retain the assembly in a generally vertically stacked orientation.

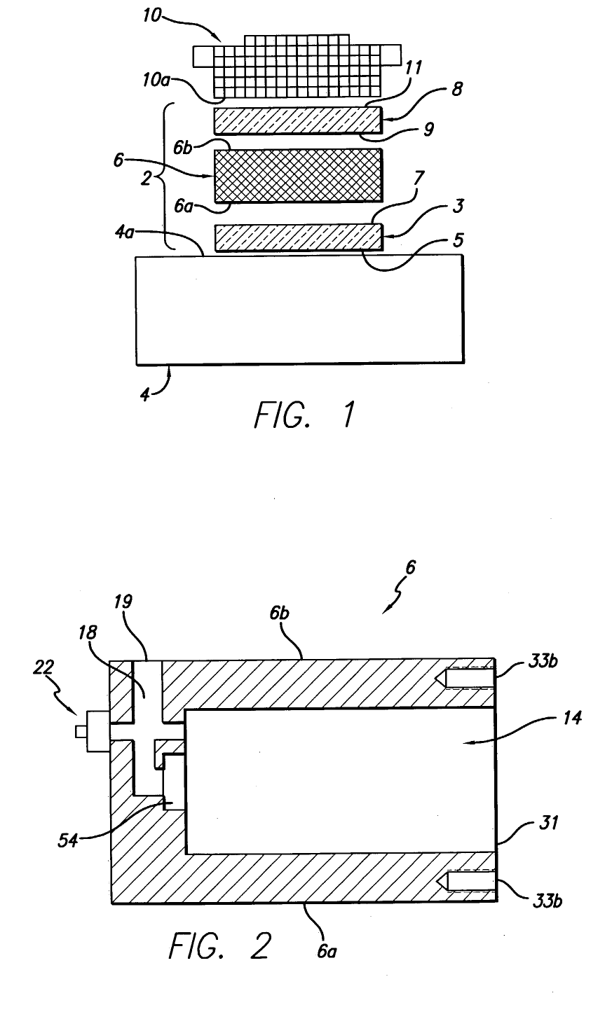

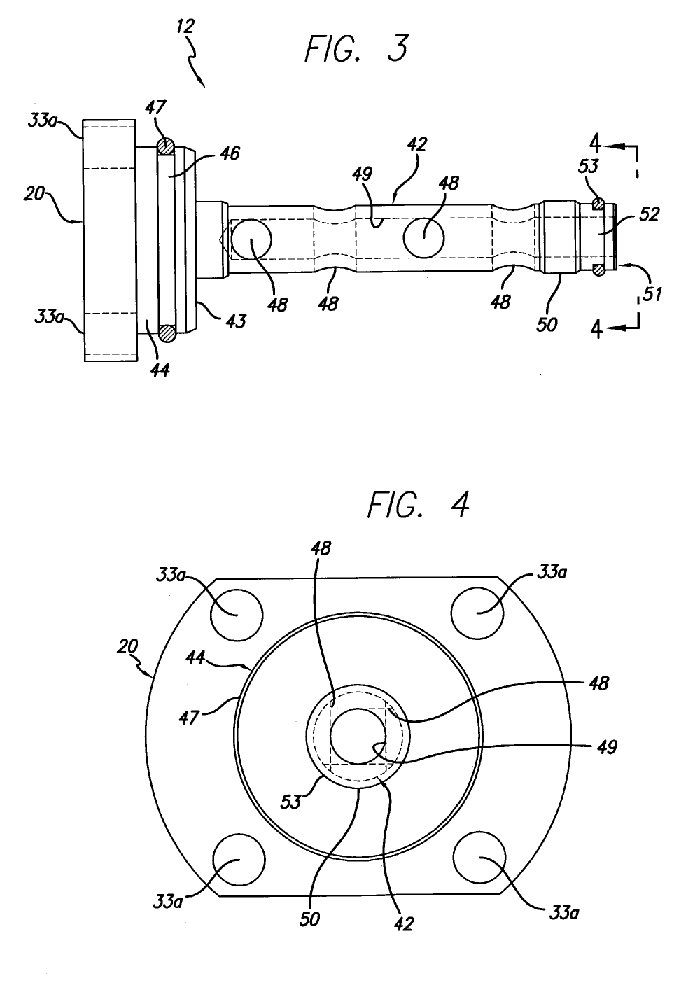

Turning to FIG. 2, sandwich filter housing 6 defines a filter element cavity 14 having a mouth 31 along a surface thereof. With references to FIGS. 3, 4 and 14, a filter cap 20 having an axially extending hollow filter element support 42 is insertable into the cavity 14. These components are collectively referred to as support 12. In addition to sandwich filter housing 6 having a filter element cavity 14, it also has, as shown in FIG. 14, a sandwich filter housing pressure port inlet 16, a sandwich filter housing pressure port inlet path 17, a sandwich filter housing pressure port outlet path 18, and a sandwich filter pressure port outlet 19. Sandwich filter housing pressure port inlet 16 and sandwich filter pressure port outlet 19 correspond to the ports 21 and 23 of the first adapter plate 3 and second adapter plate 8, respectively. Ports 21 and 23 communicate with first adapter flow path 25 and second adapter flow path 27, respectively (see, FIG. 14).

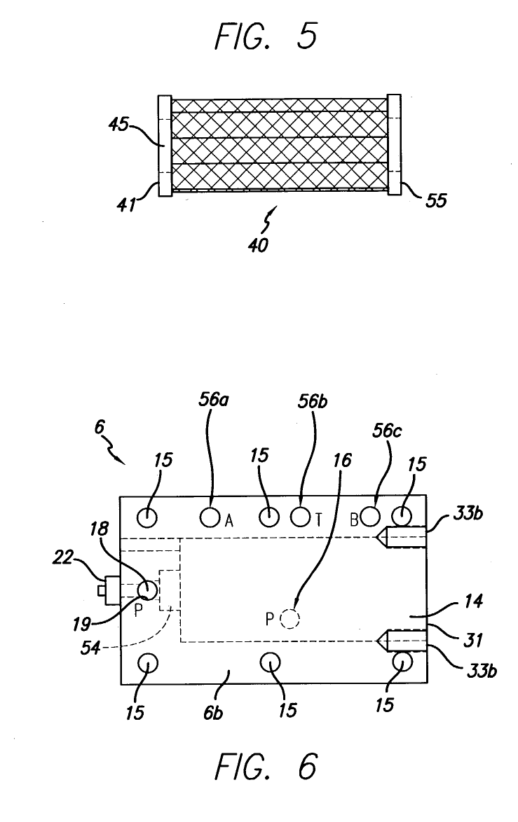

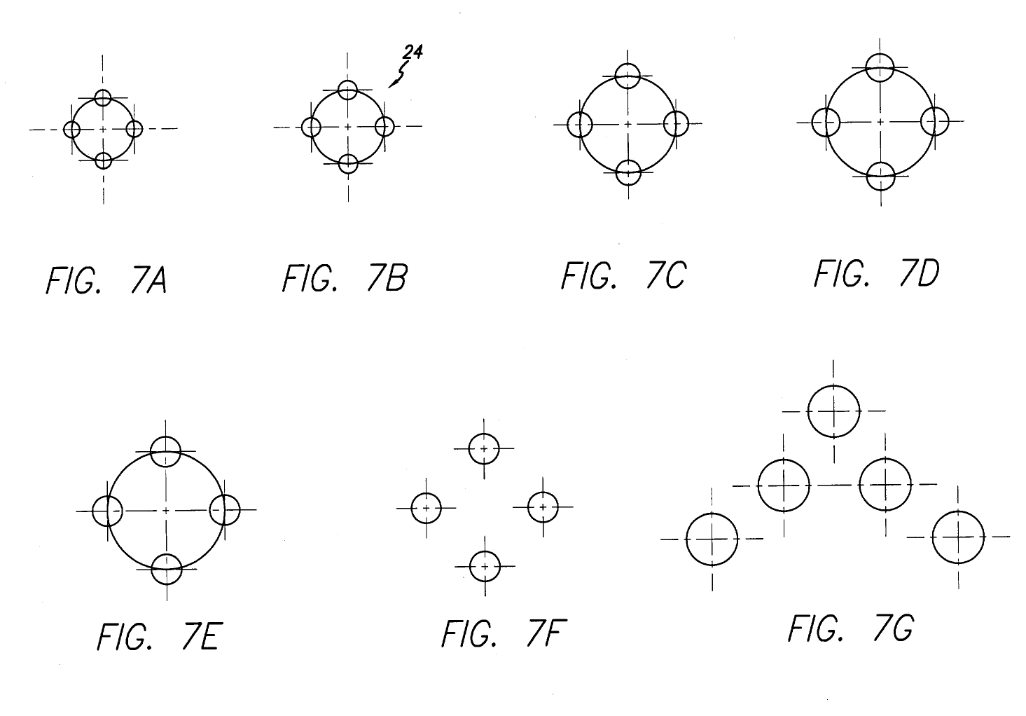

Additionally, as seen in FIG. 2, sandwich filter housing 6 has a differential pressure indicator 22, which serves to indicate the pressure drop across the filter element 40 and filter element support 42 of FIGS. 3 and 5 respectively. Anticipated port paths or patterns for first adapter plate 3 and second adapter plate 8 are shown as, but are not limited to, Examples A-G in FIG. 7.

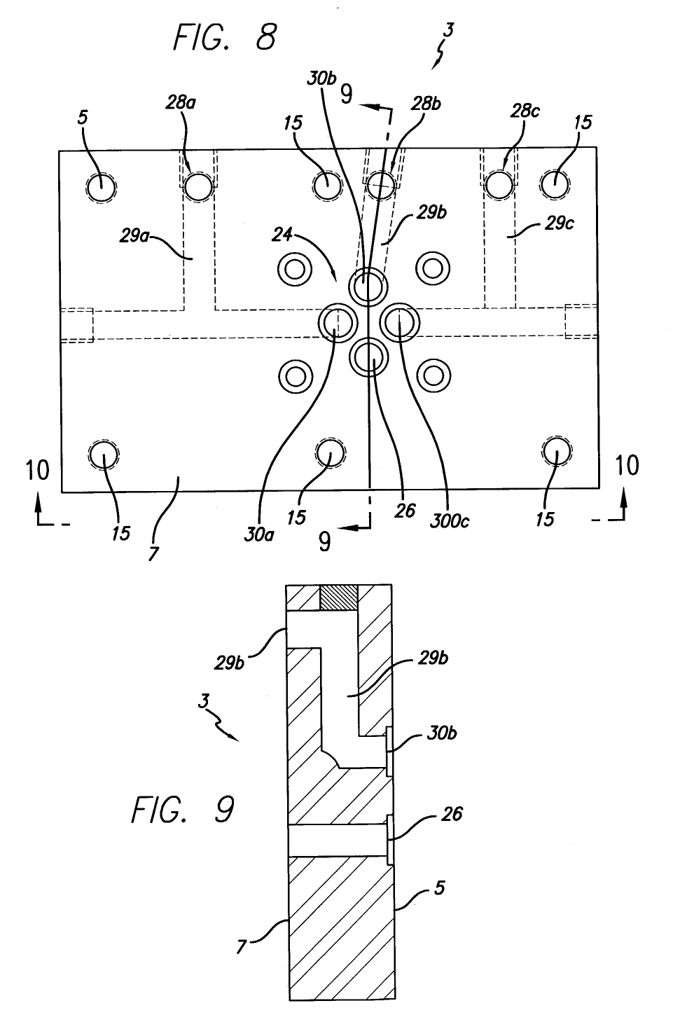

For instance, using Example B of FIG. 7, the first adapter plate 3 and second adapter plate 8 of FIGS. 8 and 11, respectively, generally represent Example B's flow porting details. Specifically, the flow porting details 24 of the first adapter plate 3 in FIG. 8 consist of first adapter plate pressure port inlet 26, first adapter plate A cylinder control port inlet 28a, first adapter plate T tank port inlet 28b, first adapter plate B cylinder control port inlet 28c; first adapter plate A cylinder control port path 29a, first adapter plate T tank port path 29b, first adapter plate B cylinder control port path 29c; and first adapter plate A cylinder control port outlet 30a, first adapter plate T tank port outlet 30b, first adapter plate B cylinder control port outlet 30c.

The flow porting details 25 of the second adapter plate 8 of FIG. 11 consist of second adapter plate pressure port inlet 32, second adapter plate pressure port path 33; second adapter plate pressure port outlet 34; second adapter plate A cylinder control port inlet 36a, second adapter plate T tank port inlet 36b, second adapter plate B cylinder control port inlet 36c; second adapter plate A cylinder control port path 37a, second adapter plate T tank port path 37b, second adapter plate B cylinder control port path 37c; and second adapter plate A cylinder control port outlet 38a, second adapter plate T tank port outlet 38b, second adapter plate B cylinder control port outlet 38c. Although various combinations of anticipated patterns exist (FIG. 7) for both first adapter plates 3 and second adapter plate 8, various patterns can be adapted to the standard sandwich filter housing pressure port inlet 16 and sandwich filter housing pressure port outlet 19 (FIG. 14). Thus, first adapter plate 3 and second adapter plate 8 allow for the adaptation to substitutions and/or upgrades.

While various details of the specific embodiment are provided here and above, it should be understood that the first adapter plate 3 and second adapter plate 8 can be designed, based on the disclosure, to provide a flow path from the process manifold 4 through the first adapter plate 3, through the sandwich filter housing 6, through the second adapter plate 8, to the servo valve 10 and return to the process manifold 4. With reference to FIG. 7, it is shown that a variety or range of port paths or patterns can be provided to accommodate different situations in which the sandwich filter assembly 2 is used with a variety of servo valve 10 configurations and process manifold 4 configurations. The sandwich filter assembly 2 of the present invention allows a single sandwich filter assembly 2 to be used with a variety of servo valve 10 and process manifold 4 combinations to provide flexibility and versatility in the application of sandwich filter assembly 2 to hydraulic systems.

Turning to FIG. 3, we focus upon the filter cap with axially extending hollow filter element support 12 and the mechanism by which a filter element 40, as shown in FIG. 5, is positioned or slid over the hollow filter element support 42 and ultimately into the cavity 14 of the sandwich filter housing 6, as shown in FIG. 14. As shown in FIG. 3, the hollow filter element support 42 has detachably affixed, on one end, filter cap 20. The cap 20 is removably attached to the housing 6 using fasteners 35 extending through and engaged in bores 33a and 33b. Other fastening systems are within the scope of this disclosure such as releasable claims and other techniques. The removable design of the support 12 and filter thereon allows the filter to be removed through the mouth 31 without removing either of the first and second adapter plates or the housing. This improves the ease and efficiency of maintaining the filter assembly.

Axially extending from the filter cap 20 is a first filter element support collar 44, a first annular groove 46, and first backup ring 47 is retained in first groove 46. Extending cylindrically from the first filter element support collar 44, first groove for backup ring 46, and first backup ring 47 is hollow filter element support 42 having a plurality of cross ports 48. The plurality of cross ports 48 communicate with a central passage 49 of the hollow filter element support 42 and allow fluid to flow therethrough. Finally, terminating at the opposite end from the first filter element support collar 44, first groove 46, and first backup ring 47 are a second filter element support collar 50, second annular groove 52, and second backup ring 53 retained in the second groove 53 for sealing the filter cap 20 with axially extending hollow filter element support 12 and filter element 40 to the filter element cavity 14 of the filter sandwich housing 6, which has a discharge outlet seat 54 as shown in FIG. 2.

A pleated filter element 40 (FIG. 5), generally a cylindrical cartridge-type filter of known construction, is axially positioned or slid over the axially elongated hollow filter element support 42 of FIG. 3. The coupled filter element 40 and filter cap with axially extending hollow filter element support 12 is then axially inserted or slid into the filter element cavity 14 of the sandwich filter housing 6. A first end 41 of the filter element 40 abuts a surface 43 of the support collar 44 with the hollow filter element support 42 extending through filter bore 45. A distal end 51 of the hollow filter support element 42 extends through a second end 53 of the filter element 40. The distal end 47 engages the discharge outlet seal 54 in the housing 6.

The filter element 40 is designed to maximize dirt holding capacity for a wide range of applications. One embodiment of the filter is a pleated cartridge filter of generally known construction. One embodiment uses a 2 micron absolute media as the filtering media. This embodiment also includes a 100 pound limit for changeout and can handle 28 grams of material at 15 gallons per minute holding capacity. Such a filter can also include a 3,000 pound collapse limit. One embodiment of this filter is designed to handle approximately 28 grams of dirt holding capacity at 15 gallons per minute, a decrease in the flow rate from 15 gallons per minute will increase the dirt holding or particulate matter holding capacity of the filter. By maximizing the dirt holding or particulate matter holding capacity of the filter, pressure drop can be minimized and can result in providing the longest range of life for the filter over a wide range of applications. The cartridge filter 40 abutts against the structures on the support 12 to define an outer chamber 39 between the exterior surface of the filter and an interior surface of the cavity 14. This chamber 39 is defined when the filter and support 12 are installed in the cavity 14 (see FIG. 14). The structure and function of the filter carried on the support results in directing hydraulic fluid flowing into the chamber area 39 to be forced or to flow through the filter material inwardly towards the hollow support 42. This structure prevent leakage of unfiltered hydraulic fluid around the filter.

The axially elongated and generally horizontally oriented cavity helps to improve draining of hydraulic fluid from the cavity when the filter is changed. The cavity 14 and support 12 are also axially oriented generally parallel to the first and second adapter plates. This orientation facilitates maintenance of the filter without having to remove the plates or housing.

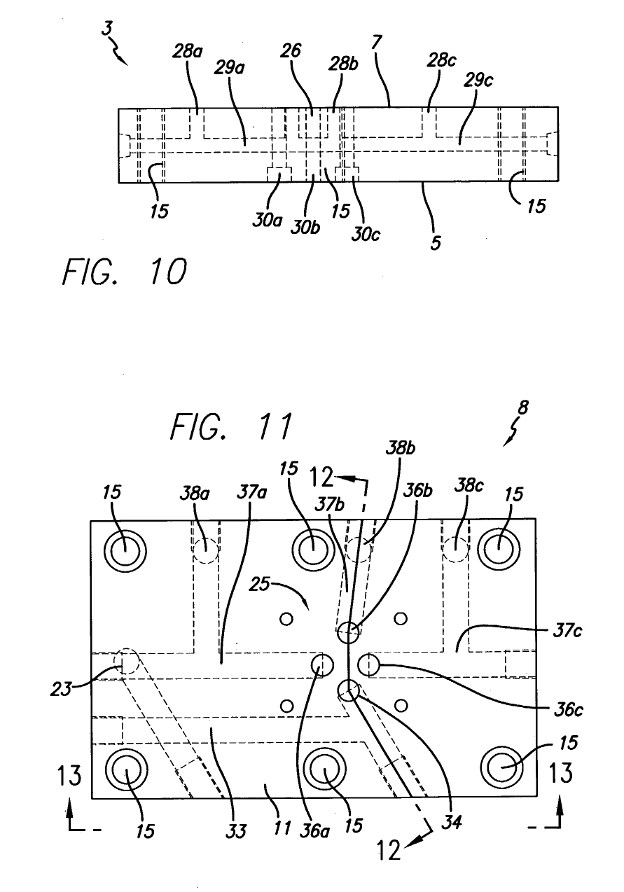

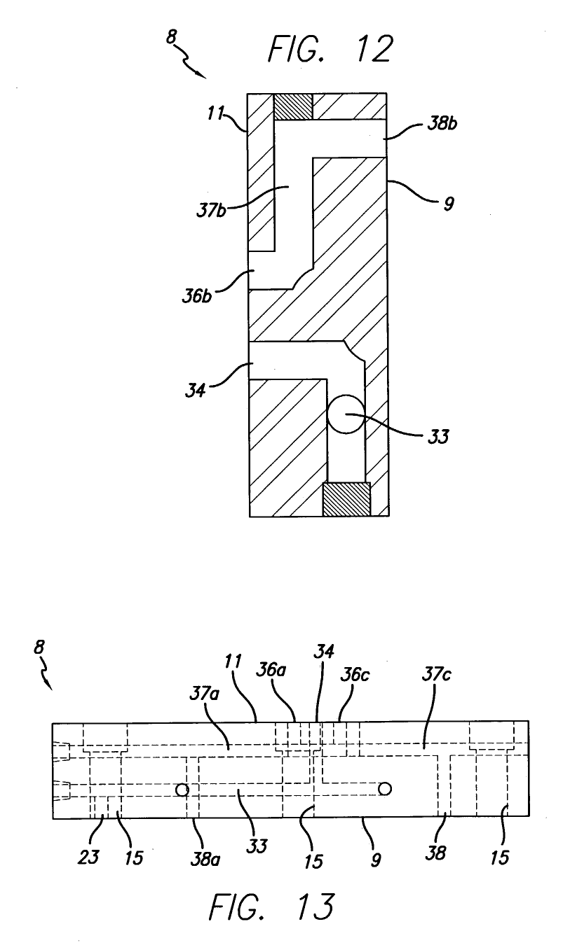

Focusing on FIGS. 3-6 and 8-14, at least one embodiment of the flow of hydraulic fluid through the present invention is described. Specifically, upon assembly of the servo sandwich filter assembly 2, hydraulic fluid passes from the process manifold 4 through, for example, the first adapter plate pressure port inlet 26 as seen in FIG. 8. After entrance from the process manifold 4 into the first adapter plate pressure port inlet 26, the hydraulic fluid flows through sandwich filter housing pressure port inlet path 17 and enters into the filter element cavity 14 of the sandwich filter housing 6 as shown in FIG. 14. Once within the filter element cavity 14, the fluid flows into and through the filter element 40 (FIG. 5) whereby contaminants and particulate matter are stripped from the fluid flow. The hydraulic fluid then proceeds through at least one of the cross ports 48 of the hollow filter element support 42 and into the central passage 49 of the hollow filter element support 42.

Once within the hollow filter support 42, the filtered hydraulic fluid flows along the hollow filter element support 42 away from the filter cap 20 toward the second filter element support collar 50, and through sandwich filter pressure port outlet path 18. Once in sandwich filter pressure port outlet path 18, the filtered hydraulic fluid flows upward and through sandwich filter housing pressure port outlet 19, whereby the filtered fluid enters into the second adapter plate 8 through the second adapter plate pressure port inlet 32, as displayed in FIGS. 14 and 11, respectively. Once the second adapter plate 8 of FIG. 11, the filtered hydraulic fluid is routed through the second adapter plate pressure port path 33. Second adapter plate pressure port path 33 routes the filtered hydraulic fluid to and through second adapter plate pressure port outlet 34 whereby it enters the servo valve 10.

Once circulated through servo valve 10, the filtered hydraulic fluid re-enters the second adapter plate 8 through second adapter plate A cylinder control port inlet 36a, second adapter plate T tank port inlet 36b, and second adapter plate B cylinder control port inlet 36c. The filtered hydraulic fluid is then ported to the second adapter plate's 8 exterior edge through second adapter plate A cylinder control port path 37a, second adapter plate T tank port path 37b, and second adapter plate B cylinder control port path 37c. Once at the exterior edge, the filtered hydraulic fluid travels downward through the second adapter plate 8 through second adapter plate A cylinder control port outlet 38a, second adapter plate T tank port outlet 38b, and second adapter plate B cylinder control port outlet 38c. The filtered fluid subsequently travels downward through sandwich filter housing A cylinder control port inlet 56a, sandwich filter housing T tank port inlet 56b, and sandwich filter housing B cylinder control port inlet 56c, as illustrated in FIG. 6. Sandwich filter housing A cylinder control port inlet 56a, sandwich filter housing T tank port inlet 56b, and sandwich filter housing B cylinder control port inlet 56c route the filtered hydraulic fluid along the edge of the sandwich filter housing 6 away from the filter element cavity 14, and down into the second adapter plate 2 through first adapter plate A cylinder control port inlet 28a, first adapter plate T tank port inlet 28b, and first adapter plate B cylinder control port inlet 28c, as illustrated in FIG. 8. The filtered hydraulic fluid is then ported to the second adapter plate's 8 center through the first adapter plate A cylinder control port path 29a, first adapter plate T tank port path 29b, and first adapter plate B cylinder control port path 29c. Finally, once at the center of the first adapter plate 3, the filtered hydraulic fluid enters the manifold through first adapter plate A cylinder control port outlet 30a, first adapter plate T tank port outlet 30b, and first adapter plate B cylinder control port outlet 30c.

In use, the assembly 2 is assembled with the housing 6 being sandwiched between the first adapter plate 3 and the second adapter plate 8. A hydraulic fluid receiving component such as a servo valve 10 is positioned abutting the second adapter plate and the assembly 2 is positioned on a hydraulic fluid providing source such as a manifold 4. Housing 6 defines the cavity 14 for receiving the filter 40. Passages are provided in the housing for passing hydraulic fluid from the hydraulic fluid source to the hydraulic fluid receiving component. At least one of the passages communicates with the cavity 14 for delivering hydraulic fluid for filtering by a filter 40 retained in the cavity.

The present disclosure also includes a method of filtering hydraulic fluid which flows from the hydraulic fluid source 4 to the hydraulic fluid receiving component 10 associated with the hydraulic fluid source 4. In the present example, the method of filtering hydraulic fluid relates to delivering hydraulic fluid from a manifold 4 to the servo valve 10. It is preferred to filter the hydraulic fluid going to the servo valve 10 in order to prevent any particles or contaminants carried in the hydraulic fluid from damaging, clogging or otherwise interfering with the operation of the servo valve. In the method of filtering, hydraulic fluid flows from the manifold 4 to the first adapter plate 3. The hydraulic fluid flows through the first adapter plate 3 to the housing 6. The hydraulic fluid then flows through the housing into the cavity 14. Once the hydraulic fluid is in the cavity it must pass through the filter 40 before reaching the hollow support 12. Once it passes through the filter 40 and reaches the hollow support 12, it passes through one of the passages 48 to the passage 49. Hydraulic fluid flowing into the passage 49 flows through the housing 6 to the second adapter plate 8. From the second adapter plate 8, the hydraulic fluid flows to the servo valve 10. Once in the servo valve it provides the hydraulic operation function and is returned to the manifold via one or more passages in the housing 6 and plates 3, 8.

Also disclosed is a method of maintaining a filter assembly for filtering hydraulic fluid flowing from the manifold to the servo valve. Using the assembly 2 as disclosed, the structure and function of the components thereof facilitate efficient and speedy removal and replacement of the filter relative to the cavity. In this method of maintaining the filter assembly, the filter 40 can be periodically removed by disengaging the cap 20 from the housing 6. Once the cap 20 is released from the housing 6, the support 12 can be removed from the cavity 14. Once the support 12 is removed from the cavity 14 the filter 40 can be removed from the support. The removed filter 40 can be cleaned, disposed of, or otherwise treated, as appropriate. At the end of the treating cycle or disposal cycle a fresh filter 40 can be placed on the support 12. The support 12 including the filter 40 is returned to the cavity 14 and the cap 20 is reattached using the fasteners 35.

In a maintenance operation, the assembly 2 of the present disclosure provides fast and efficient access to the assembly 2. The generally horizontal orientation of the cavity 14, support 12 and filter 40 allow these components to be quickly and efficiently removed and replaced without disturbing any surrounding structures. During a maintenance operation, the filter 40 can be quickly replaced by one standing nearby and returned to the cavity 14 for continued operation. This efficient servicing of the filter helps minimize the downtime associated with the method of maintaining the filter assembly. Reduced downtime also improves the cost and time efficiency of the system associated with the hydraulic system.

This efficiency is beneficial in the replacement of the filter assembly 2 in the event of clogging or damage to the assembly 2. For example, if the filter housing 6 needs to be replaced the fastening structures are disengaged and removed from the servo valve 10 and the manifold 4. Because the housing 6 is generally a generic housing which can be used in multiple situations, by means of the adapter plates, one type of housing can be maintained in replacement inventory thereby helping to improve the responsiveness when replacement is needed. Improving responsiveness helps minimize downtime which might otherwise be required as seen with prior art devices.

With the foregoing in mind, the disclosure also provides for a kit of adapter plates. In this regard, a variety or range of standard adapter plates can be provided and retained in inventory. In the event an adapter plate is damaged, one of the inventory of adapter plates can be used to replace a damaged adapter plate. Adapter plates are much less expensive to produce than an entire housing structure. As such, the present device provides improvements over the prior art by allowing only the adapter plate to be replaced instead of the entire housing assembly in the event the adapter plate portion needs replacement. Flexibility is also improved as a result of the modular assembly 2 such that in the event a component is not available or is needed and inventory is not available, the component can be swapped from a lower priority hydraulic system and placed in a higher priority hydraulic system.

While a preferred embodiment of the servo sandwich filter is shown and disclosed, it is envisioned that those skilled in the art may devise various modifications and equivalents without departing from the spirit and scope of the disclosure.

What is claimed is:

1. A filter assembly for filtering hydraulic fluid flowing from a hydraulic fluid source to a hydraulic fluid receiving component associate with the hydraulic fluid source, the filter assembly comprising:
a housing;
the housing defining a cavity for receiving a filter;
passages in the housing for passing hydraulic fluid from a hydraulic fluid source to a hydraulic fluid receiving component, at least one of the passages communicating with the cavity for delivering hydraulic fluid for filtering by a filter retained in the cavity;
at least one first adapter plate adapted for being positioned between a hydraulic fluid source and the housing, the first adapter plate including passages extending therethrough for matching ports on a hydraulic fluid source and the housing; and
at least one second adapter plate adapted for being positioned between the housing and a hydraulic fluid receiving component, the second plate including passages extending therethrough for matching ports on the housing and a hydraulic fluid receiving component.

2. The filter assembly as in claim 1 further comprising a filter retained in the cavity defined by the housing, the filter being positioned in a flow path of hydraulic fluid through the housing so as to filter the hydraulic fluid flowing from a hydraulic fluid source to the hydraulic fluid receiving component.

3. The filter assembly as in claim 1 wherein the hydraulic fluid receiving component is a servo valve.

4. The filter assembly as in claim 1 wherein the hydraulic fluid receiving component is a proportional valve.

5. The filter assembly as in claim 1 wherein the hydraulic fluid source is a hydraulic fluid manifold.

6. The filter assembly as in claim 1 further comprising the cavity having generally horizontal orientation generally parallel to the first and second adapter plates, the cavity defining a mouth accessible from a side of the housing without removing either of the first and second adapter plates.

7. The filter assembly as in claim 6 further comprising a hollow filter support for extending into the cavity and removably supporting a filter in the cavity.

8. The filter assembly as in claim 7 further comprising a generally hollow filter for use in the filter assembly, the hollow filter being positioned over the hollow filter support, the support defining a passage therethrough communicating with a passage flowing to the hydraulic fluid receiving component, hydraulic fluid entering the cavity flowing through the filter and into the hollow support and then to the hydraulic fluid receiving component.

9. The filter assembly as in claim 7 further comprising a cap attached to the hollow support, the cap covering the mouth of the cavity, the cap and hollow support carried thereon being attached to the housing by one or more fasteners for removable attachment to the housing.

10. The filter assembly as in claim 1 further comprising a kit of at least one first adapter plate and at least one second adapter plate, the kit including first and second adapter plates for use with one or more specific port patterns compatible with a hydraulic fluid source port patterns and port patterns on hydraulic fluid receiving components, each of the first and second adapter plates in the kit being compatible with the port patterns of corresponding surfaces of the housing to which the first and second adapter plates attached.

11. A filter assembly for filtering hydraulic fluid flowing from a hydraulic fluid source to a hydraulic fluid receiving component associate with a hydraulic fluid source, the filter assembly comprising:
a housing;
the housing defining a cavity for receiving a filter;
passages in the housing for passing hydraulic fluid from a hydraulic fluid source to a hydraulic fluid receiving component, at least one of the passages communicating with the cavity for delivering hydraulic fluid for filtering by a filter retained in the cavity;
at least one first adapter plate adapted for being positioned between a hydraulic fluid source and the housing, the first adapter plate including passages extending therethrough for matching ports on a hydraulic fluid source and the housing;
at least one second adapter plate adapted for being positioned between the housing and a hydraulic fluid receiving component, the second plate including passages extending therethrough for matching ports on the housing and a hydraulic fluid receiving component;
the cavity having generally horizontal orientation generally parallel to the first and second adapter plates, the cavity defining a mouth accessible from a side of the housing without removing the first and second adapter plates; and
a filter retained in the cavity defined by the housing, the filter being positioned in a flow path of hydraulic fluid through the housing so as to filter the hydraulic fluid flowing from a hydraulic fluid source to the hydraulic fluid receiving component.

12. The filter assembly as in claim 11 wherein the hydraulic fluid receiving component is a servo valve.

13. The filter assembly as in claim 11 wherein the hydraulic fluid receiving component is a proportional valve.

14. The filter assembly as in claim 11 wherein the hydraulic fluid source is a hydraulic fluid manifold.

15. The filter assembly as in claim 11 further comprising a hollow filter support for extending into the cavity and removably supporting a filter in the cavity; and
the filter used in the filter assembly being a generally hollow filter positionable over the hollow filter support, the support defining a passage therethrough communicating with a passage flowing to the hydraulic fluid receiving component, hydraulic fluid entering the cavity flowing through the filter and into the hollow support and then to the hydraulic fluid receiving component.

16. The filter assembly as in claim 15 further comprising a cap attached to the hollow support, the cap covering the mouth of the cavity, the cap and hollow support carried thereon being attached to the housing by one or more fasteners for removable attachment to the housing.

17. The filter assembly as in claim 11 further comprising a kit of at least one first adapter plate and at least one second adapter plate, the kit including first and second adapter plates for use with one or more specific port patterns compatible with hydraulic fluid source port patterns and port patterns on hydraulic fluid receiving components, each of the first and second adapter plates in the kit being compatible with the port patterns of corresponding surfaces of the housing to which the first and second adapter plates attached.

18. A housing for use with a filter assembly for filtering hydraulic fluid flowing from a hydraulic fluid source to a hydraulic fluid receiving component associate with a hydraulic fluid source, the housing comprising:
the housing defining a cavity for receiving a filter;
passages in the housing for passing hydraulic fluid from a hydraulic fluid source to a hydraulic fluid receiving component, at least one of the passages communicating with the cavity for delivering hydraulic fluid for filtering by a filter retained in the cavity;
the cavity having generally horizontal orientation generally parallel to the first and second adapter plates, the cavity defining a mouth accessible from a side of the housing without removing the first and second adapter plates; and
a filter retained in the cavity defined by the housing, the filter being positioned in a flow path of hydraulic fluid through the housing so as to filter the hydraulic fluid flowing from a hydraulic fluid source to the hydraulic fluid receiving component.

19. The filter assembly as in claim 18 further comprising a hollow filter support for extending into the cavity and removably supporting a filter in the cavity; and
the filter used in the filter assembly being a generally hollow filter positionable over the hollow filter support, the support defining a passage therethrough communicating with a passage flowing to the hydraulic fluid receiving component, hydraulic fluid entering the cavity flowing through the filter and into the hollow support and then to the hydraulic fluid receiving component.

20. The filter assembly as in claim 19 further comprising a cap attached to the hollow support, the cap covering the mouth of the cavity, the cap and hollow support carried thereon being attached to the housing by one or more fasteners for removable attachment to the housing.

21. A method of filtering hydraulic fluid flowing from a hydraulic fluid source to a hydraulic fluid receiving component associated with a hydraulic fluid source, the method comprising the steps of:
providing a housing, the housing defining a cavity for receiving a filter;
providing passages in the housing for passing hydraulic fluid from a hydraulic fluid source to a hydraulic fluid receiving component, at least one of the passages communicating with the cavity for delivering hydraulic fluid for filtering by a filter retained in the cavity;
providing at least one first adapter plate adapted for being positioned between a hydraulic fluid source and the housing, the first adapter plate including passages extending therethrough for matching ports on a hydraulic fluid source and the housing;
providing at least one second adapter plate adapted for being positioned between the housing and a hydraulic fluid receiving component, the second plate including passages extending therethrough for matching ports on the housing and a hydraulic fluid receiving component;
flowing hydraulic fluid from a hydraulic fluid source to the first adapter plate;
flowing hydraulic fluid through the first adapter plate to the housing;
flowing the hydraulic fluid through the housing to the cavity;
flowing the hydraulic fluid from the cavity through the filter retained in the cavity;
flowing the hydraulic fluid from the filter to the housing;
flowing the hydraulic fluid from the housing to the second adapter plate;
flowing the hydraulic fluid from the second adapter plate to the hydraulic fluid receiving component; and
flowing the hydraulic fluid from the hydraulic fluid receiving component to the housing and back to a hydraulic fluid source.

22. A method of maintaining a filter assembly for filtering hydraulic fluid flowing from a hydraulic fluid source to a hydraulic fluid receiving component associate with a hydraulic fluid source, the method comprising the steps of:
providing a housing, the housing defining a cavity for receiving a filter;
providing passages in the housing for passing hydraulic fluid from a hydraulic fluid source to a hydraulic fluid receiving component, at least one of the passages communicating with the cavity for delivering hydraulic fluid for filtering by a filter retained in the cavity;
providing the cavity in a generally horizontal orientation generally parallel to a hydraulic fluid source to which the housing is attached, the cavity defining a mouth accessible from a side of the housing without removing the housing from a hydraulic fluid source;
providing a filter retained in the cavity defined by the housing, the filter being positioned in a flow path of hydraulic fluid through the housing so as to filter the hydraulic fluid flowing from a hydraulic fluid source to a hydraulic fluid receiving component;
removing the filter from the cavity;
replacing the removed filter with a clean filter; and
returning the filter to the cavity.

23. A method of maintaining a filter assembly as in claim 22 further comprising the step of providing a hollow filter support for extending into the cavity and removably supporting a filter in the cavity;
providing a removable, generally hollow filter for use in the filter assembly, the hollow filter being positioned over the hollow filter support, the support defining a passage therethrough communicating with a passage flowing to the hydraulic fluid receiving component, hydraulic fluid entering the cavity flowing through the filter and into the hollow support and then to the hydraulic fluid receiving component;
removing the filter from the cavity;
removing the filter from the filter support;
placing a clean filter on the filter support; and
returning the filter and the filter support to the cavity.

24. A method of maintaining a filter assembly as in claim 22 further comprising the step of draining the cavity upon removing the filter and filter support, the generally horizontal orientation of the cavity facilitating draining of the cavity to improve removal of fluid and particles from the cavity.
